(19) United States
(12) Patent Application Publication
(10) Pub. No.: US 2002/0007462 A1
(43) Pub. Date: Jan. 17, 2002

(54) User authentication system

(76) Inventor: Masaki Omata, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/873,450

(22) Filed: Jun. 5, 2001

(30) Foreign Application Priority Data
Jul. 11, 2000 (JP) 2000-209857

(51) Int. Cl. H04L 9/32

(52) U.S. Cl. 713/202

(57) ABSTRACT

A user authentication system comprises a user authentication database which stores, in correlation with each user, a voiceprint information obtained when a user pronounces his/her company member ID. Upon receipt of a log-in request designating a member ID from a cellular phone via a data communication network, a web server generates a onetime ID, sets and registers in the user authentication database in correlation with the company member ID a disallowed state of log-in using the onetime ID, and transmits the onetime ID back to the cellular phone. When a connection via a telephone network is established, a CTI server invites the user to pronounce the company member ID and executes voice recognition. An authentication server collates the voiceprint information stored for the member ID identified by the voice recognition, with the audibly input member ID. When the authentication is successful, log-in is allowed and he cellular phone transmits the onetime ID to the CTI server to automatically log in. In this way, the system can reduces the key input load imposed on the user while maintaining a high level of security.

### BACKGROUND OF THE INVENTION

1. Field of the Invention

The present invention relates to a user authentication system, and more particularly to a user authentication system which reduces the burden imposed on a user when logging in without sacrificing strength of security.

2. Description of the Related Art

In systems of which use is permitted only to authenticated users, a typical method for performing authentication is to have the potential user input a user name and a password via a terminal device. In recent years, Internet cellular phones (hereinafter also referred to simply as “cellular phone”) provided with an Internet function such as i-Mode (trademark) or the like are widely used. In accordance with this trend, a number of companies have established proprietary systems configured such that the company members can log into the company computers from their cellular phones. In such systems, security must be assured to prevent unauthorized entry into the company system by unauthorized parties.

To reinforce security, passwords are often made complex by, for example, adopting longer password and using a mixture of upper and lowercase letters, such that a password match would not readily occur when random combinations of alphabets and numbers are input. Further, validity period of a password is typically made short so as to prevent re-use of a stolen password.

However, when a password is made complex, particularly by mixing alphabets and numbers, input of the password via a cellular phone must be conducted through many mode switching operations using a combination of number keys and other keys. A password input operation can therefore be extremely troublesome. While specific manipulations may differ depending on the cellular phone models, to input 2 letters “9v” using the keys of a cellular phone, for example, a total of 8 key manipulations, i.e., [9] [mode] [mode] [mode] [mode] [8] [8] [8] where each bracketed expression [ ] defines one key manipulation), would be necessary. It can easily be recognized that a password designating operation via a cellular phone is quite troublesome when such an operation must be repeated for a password of today's typical length.

### SUMMARY OF THE INVENTION

The present invention was conceived in light of the above problems. An object of the present invention is to provide a user authentication system which, while maintaining a high level of security strength, reduces the input load imposed on the user.

To accomplish this object, the present invention provides a user authentication system which, before permitting logging in from a communication terminal device with a voice input function, conducts user authentication based on user identification information uniquely identifying each user and a password corresponding to the user identification information, the system comprising a user authentication database for storing user identification information and voiceprint information while the two are being correlated, the voiceprint information being acquired when a user pronounces his/her user identification information, wherein the user authentication is performed by collating a voiceprint information identified by searching in the user authentication database based on a user identification information in code format received via a data communication network from the communication terminal device with a voice input function, with a user identification information in voice format received via a telephone network from the communication terminal device.

According to another aspect, a user authentication system of the present invention comprises a communication terminal device with a voice input function, the communication terminal device being capable of logging into a system, use of which is allowed only after performing user authentication based on user identification information uniquely identifying each user and a password corresponding to the user identification information; a user authentication database for storing user identification information and voiceprint information while the two are being correlated, the voiceprint information acquired when a user pronounces his/her user identification information; a onetime identification information managing means which generates onetime identification information upon receipt of a code-format user identification information from the communication terminal device via a data communication network, transmits the generated onetime identification information to the communication terminal device via the data communication network, and records, in the user authentication database in correlation with the user identification information, a disallowed state of a log-in designating the onetime identification information as the password; and a user authenticating means which, upon receipt of a voice-format user identification information from the communication terminal device via a telephone network, performs voiceprint authentication based on the voice-format user identification information by referring to the user authentication database, and, when the voiceprint can be authenticated, changes to an allowed state the state recorded in the user authentication database concerning the log-in by the onetime identification information; wherein the communication terminal device with a voice input function comprises a code-format user identification information transmitting means for transmitting to the onetime identification information managing means, as the code-format user identification information, identification information belonging to the individual communication terminal device or to the exclusive user of the individual communication terminal device; a voice-format user identification information transmitting means for receiving user identification information input by the user's voice and transmitting the input information to the user authenticating means as the voice-format user identification information; and an automatic log-in means for, after the authentication by the user authenticating means is completed, automatically logging into the system using the onetime identification information received from the onetime identification information managing means.

According to a further aspect, the user authenticating means comprises a voice recognizer for executing voice recognition with respect to the voice-format user identification information received from the communication terminal device via the telephone network, so as to generate the received information in a code format; and a voiceprint authenticator for executing voice authentication by collating a voiceprint information identified by searching in the user authentication database based on the user identification information generated by the voice recognizer with the voice-format user identification information received from the communication terminal device.

In another aspect, the code-format user identification information transmitting means displays on the communication terminal device a log-in display screen received from the system via the data communication network, and transmits to the onetime identification information managing means, as the code-format user identification information, a user name input through the log-in display screen.

In another aspect, after receiving the onetime identification information from the onetime identification information managing means via the data communication network, the voice-format user identification information transmitting means transmits to the user authenticating means, as the voice-format user identification information, the audible data input by the user following an audio guidance provided by the user authenticating means via the telephone network.

According to still another aspect, the user authentication system further comprises a onetime identification information deleting means for, automatically deleting the corresponding onetime identification information from the user authentication database upon completion of a user log-in from the communication terminal device.

In another aspect, the communication terminal device is a cellular phone provided with an Internet function.

According to the present invention, onetime identification information which need not be input by the user is provided separately from the user identification information and user authentication is performed by voiceprint collation. With this configuration, the input load imposed on the user when logging in can be further reduced while still maintaining security of the system.

Particularly, the present invention sets and maintains an allowed/disallowed state of log-in based on the onetime identification information generated in response to a log-in request. In this way, unauthorized log-in can be prevented during the short time interval between the generation of the onetime identification information and the completion of log-in by an authorized user using the generated onetime identification information.

Moreover, after completion of the user log-in, the corresponding onetime identification information is automatically deleted from the user authentication database, thereby preventing unauthorized log-in through re-use of the onetime identification information.

### BRIEF DESCRIPTION OF THE DRAWINGS

FIG. 1 is a system configuration diagram illustrating an embodiment of the user authentication system according to the present invention.

FIG. 2 is a flowchart showing the user authentication processing according to the embodiment shown in FIG. 1.

FIG. 3 is a flowchart showing the voiceprint collation processing according to the embodiment shown in FIG. 1.

FIG. 4 is a diagram illustrating screens displayed to the user during user authentication according to the embodiment shown in FIG. 1.

### DESCRIPTION OF THE PREFERRED EMBODIMENT

A preferred embodiment of the present invention will next be described referring to the drawings. This embodiment illustrates a case in which a user authentication system according to the present invention is implemented in a proprietary system operated by one corporation.

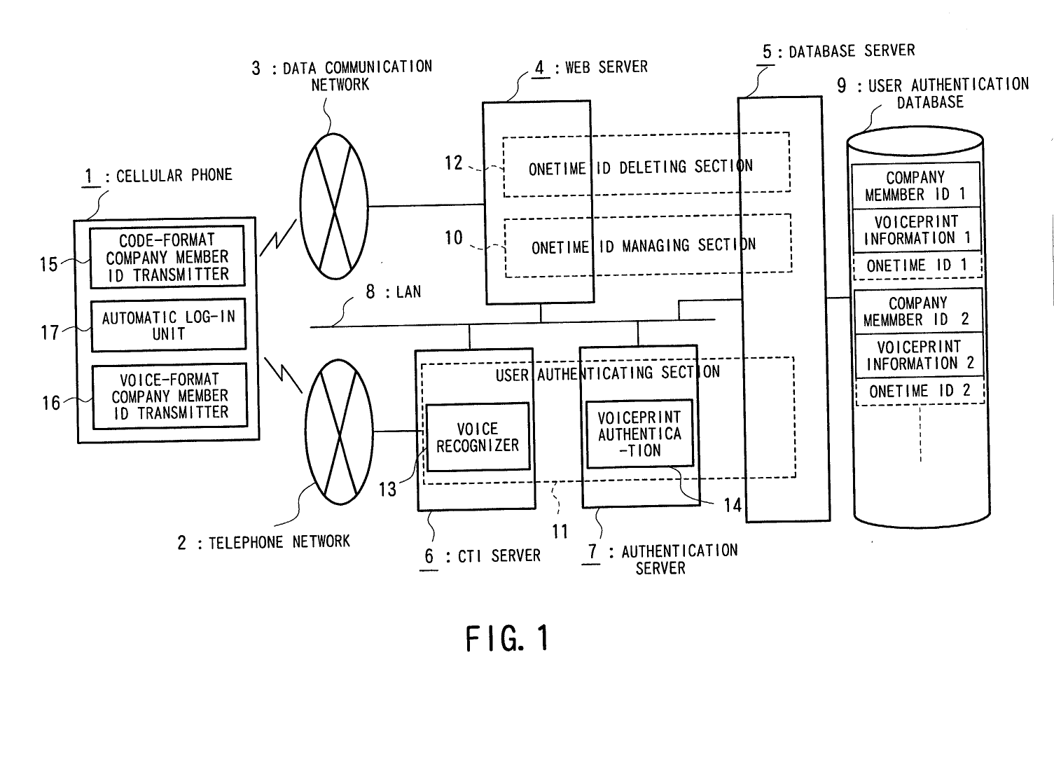

FIG. 1 is a system configuration diagram illustrating one embodiment of the user authentication system according to the present invention. A user of a cellular phone 1 with an Internet function can converse with a party connected online via a packet communication network of the cellular phone manufacturer, and can also connect to the Internet and use various services offered by a service provider. When carrying on a conversation in a usual manner, a channel connection is established via a telephone network 2 with a party designated by a telephone number. When accessing the Internet, a channel connection is established via a data communication network 3 with a log-in site specified by designating an address. According to the present embodiment, the Internet is included in the data communication network 3. Further, the packet communication network of the cellular phone manufacturer constitutes a part of both the data communication network 3 and the telephone network 2. However, to simplify illustration and understanding, FIG. 1 does not show those details.

The company proprietary system according to the present embodiment is configured by connecting, using a LAN 8, a web server 4, a database server 5, a CTI (Computer Telephony Integration) server 6, and an authentication server 7. The web server 4 is a server for providing a service in response to a request from the cellular phone 1, and performs data communication with the cellular phone 1 via the data communication network 3. The database server 5 is a server for managing the user authentication database 9. The CTI server 6 is a server for integrating the functions of a computer and a telephone, and includes a function of recognizing a voice received from the cellular phone 1 via the telephone network 2. The authentication server 7 is a server for executing voiceprint authentication.

In the user authentication database 9, a company member ID and a voiceprint information obtained when the company member ID is pronounced by the corresponding company member are stored in correlation to one another. The company member ID of the present embodiment corresponds to the user identification information registered in the company proprietary system for identifying a user. The voiceprint information of a company member must be registered before that person can access the company proprietary system using a cellular phone. As described below in further detail, a onetime ID, which is generated and deleted during an authentication process, is stored in correlation with the company member ID. A onetime ID is a password that can be used only once.

With the above arrangement, each of the function blocks of onetime ID managing section 10, user authenticating section 11, and onetime ID deleting section 12 are configured extending across the servers 4˜7 as shown in FIG. 1. In other words, each function block is realized by installing separate modules in the respective servers. The function blocks operate as follows. The onetime ID managing section 10 generates a onetime ID upon receiving a code-format company member ID from the cellular phone 1 via the data communication network. The onetime ID managing section 10 then transmits the generated onetime ID back to the cellular phone 1 via the data communication network 3, and also records, in the user authentication database 9 in correlation with the company member ID concerned, a disallowed state of the log-in designating the onetime ID as the password. Among these processing functions executed by the onetime ID managing section 10, access to the database is performed by a functional module provided in the database server 5. The user authenticating section 11 includes a voice recognizer 13 provided in the CTI server 6 and a voiceprint authenticator 14 provided in the authentication server 7. The voice recognizer 13 executes voice recognition with respect to the voice-format company member ID received from the cellular phone 1 via the telephone network 2, so as to generate the received company member ID in a code format. The voiceprint authenticator 14 identifies a voiceprint information by searching in the user authentication database 9 based on the company member ID generated by the voice recognizer 13, and executes voice authentication by collating the identified voiceprint information with the voice-format company member ID received from the cellular phone 1. When authentication is successful, the user authenticating section 11 resets the state concerning the log-in by the onetime ID recorded in the user authentication database 9 to an allowed state. Upon completion of the user log-in from the cellular phone 1, the onetime ID deleting section automatically deletes the corresponding onetime ID from the user authentication database 9.

The cellular phone 1 of the present embodiment includes a code-format company member ID transmitter 15 for transmitting a code-format company member ID to the onetime ID managing section 10 provided in the CTI server 6, a voice-format company member ID transmitter 16 for transmitting to the voice recognizer 13 a company member ID input by the user's voice, and an automatic log-in unit 17 for automatically logging into the system using the onetime ID received from the onetime ID managing section 10 after completion of the user authentication. When the communication terminal device with a voice input function is realized as a cellular phone, as in the present embodiment, the function of the voice-format company member ID transmitter 16 is a processing function naturally provided as a part of typical telephone function, even though it is apparently not indicated in FIG. 1. When the cellular phone has an Internet function, the function of the code-format company member ID transmitter 15 is also a naturally provided processing function. The cellular phone 1 further includes other various functions such as a screen display function, but description of such typical functions will not be set forth in this specification because those functions do not constitute the main features of the present embodiment. The same is true for the servers 4˜7.

A main feature of the present embodiment having the above-described configuration is that the voiceprint authenticating function and the onetime password issuing function are effectively linked, such that a user is allowed to log into the company system from the cellular phone 1 without performing key strokes to input a password. According to the present embodiment, voiceprint information and a onetime password are effectively used to reduce the input load imposed on the user while maintaining the level of security strength.

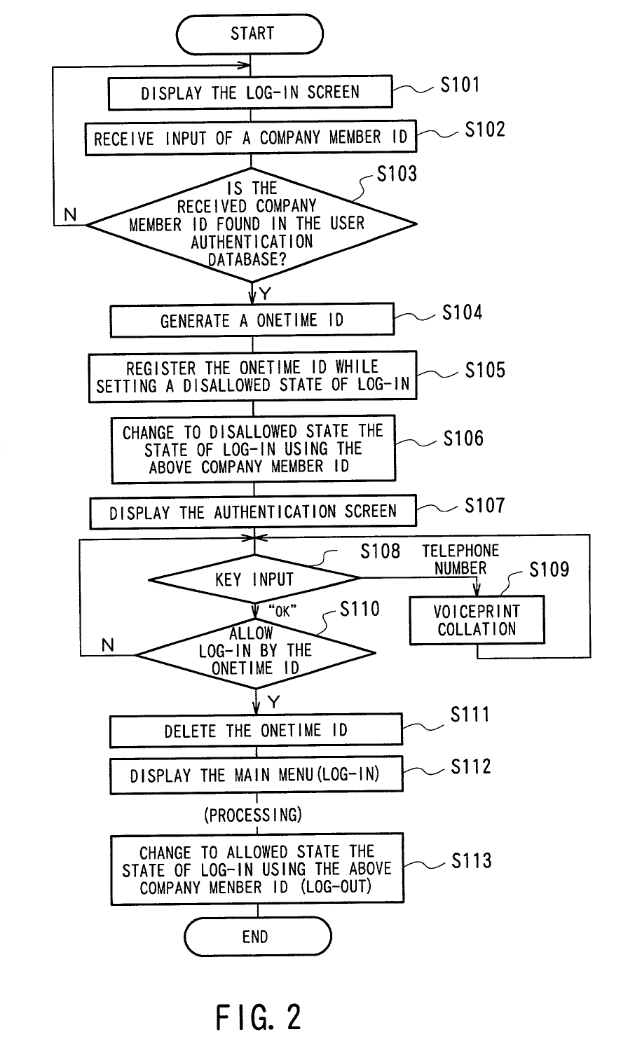

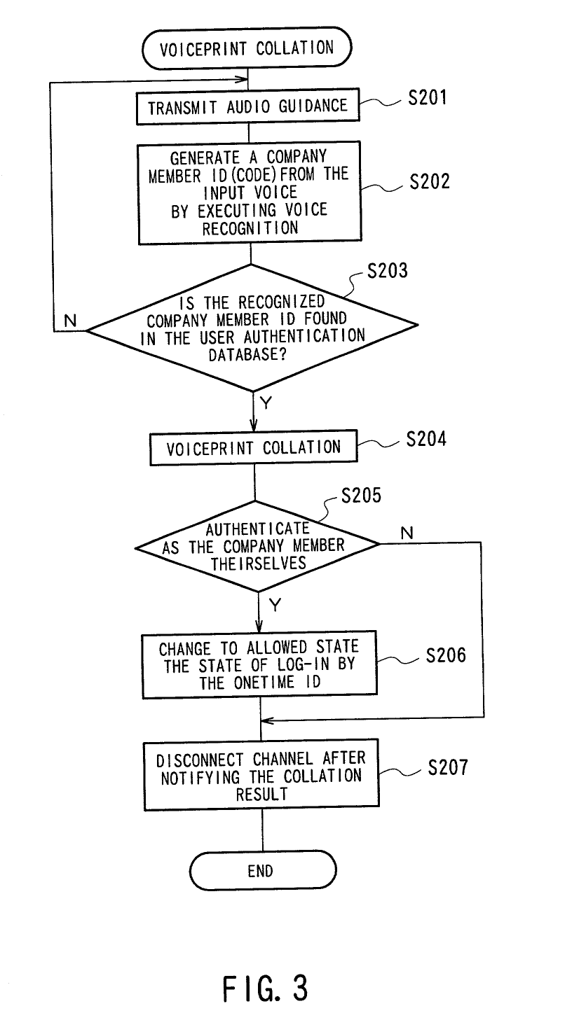

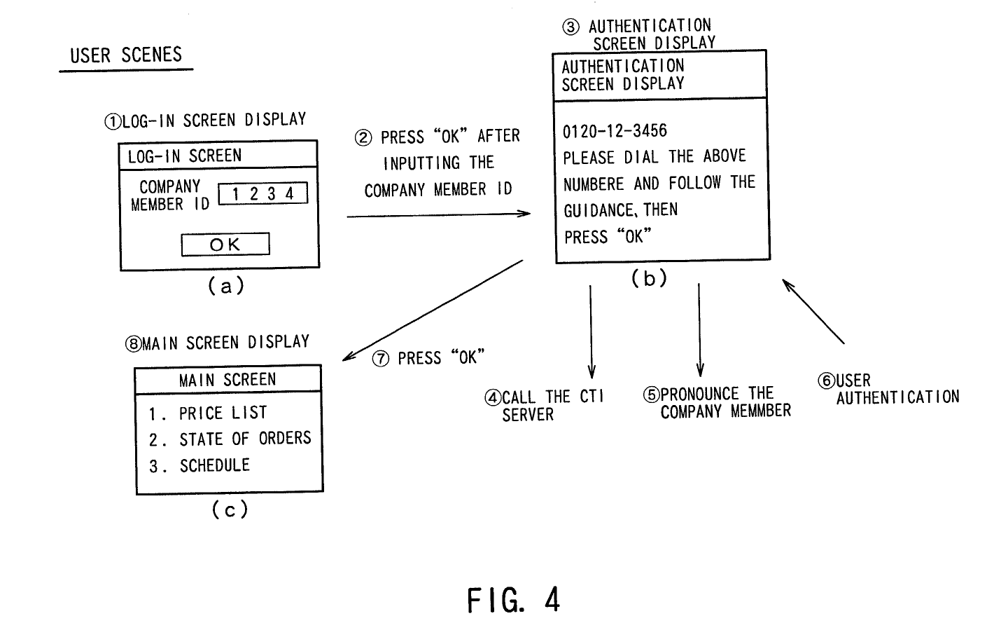

Operations carried out when a user (company member) attempts to log into the company proprietary system from the cellular phone 1 in the present embodiment will next be described referring to the flowcharts of FIGS. 2 and 3 and the user scenes shown in FIG. 4.

When a user accesses the web server 4 using the Internet function of the cellular phone 1, the cellular phone 1 displays the log-in screen downloaded from the web server 4 (step 101). An example of the log-in screen is shown in FIG. 4(a). At this point, the user has not yet logged into the company system. The user inputs his/her own company member ID through the log-in screen and presses the OK button. Upon receiving the input of the company member ID (step 102), the cellular phone 1 transmits the company member ID to the web server 4 by using the code-format company member ID transmitter 15.

The web server 4 confirms, via the database server 5, whether or not the received company member ID is registered in the user authentication database 9. If not registered, the log-in screen is again displayed on the cellular phone 1 (step 103, 101). If registered, a onetime ID is generated (step 104). Subsequently, the state of the log-in designating the generated onetime ID as the password is set to a disallowed state, and recorded in the user authentication database 9 in correlation with the company member ID concerned (step 105). Further, the state of the log-in designating the company member ID as the user name is changed to a disallowed state (step 106). The allowed/disallowed state of each log-in based on the company member ID and the onetime ID can be retained in the user authentication database 9 by employing, for example, flag information. By setting to a disallowed state the state of the log-in designating the onetime ID as the password, unauthorized log-in with the onetime ID before user authorization can be prevented. Furthermore, by setting to a disallowed state the state of the log-in designating the company member ID as the user name, multiple log-ins by the same user are prohibited in the company proprietary system of the present embodiment to thereby prevent unauthorized log-ins. The web server 4 subsequently transmits the generated onetime ID back to the cellular phone 1. At the same time, the web server 4 also transmits an authentication screen to the cellular phone 1.

The cellular phone 1 temporarily retains the onetime ID received from the web server 4 while displaying the authentication screen (step 107), but the onetime ID is not displayed. The user follows guidance displayed on the authentication screen shown in FIG. 4(b) to input the telephone number of the CTI server 6 displayed on the screen. In response to the keystroke input by the user, the cellular phone 1 performs a dialing transmission to establish a channel connection with the CTI server 6. Voice collation by the user authenticator 11 is then performed (step 108, 109). Details of the voice collation processing are shown in FIG. 3.

After the channel connection with the CTI server 6 is established, the CTI server 6 transmits an audio guidance inviting the user to pronounce his/her company member ID (step 201). Following the audio guidance from the CTI server 6, the user pronounces the company member ID. That is, the user pronounces the company member ID instead of inputting through key manipulations a password composed of a long and complex sequence of letters. The voice recognizer 13 of the CTI server 6 executes voice recognition with respect to the sound pronounced by the user, so as to acquire the company member ID in a code format (step 202).

Subsequently, the voiceprint authenticator 14 of the authentication server 14 searches in the user authentication database 9 based on the company member ID (in code format) generated by the voice recognizer 13 to confirm whether the company member ID is registered (step 203). According to the present embodiment, even when a vast number of data are registered, the search in the user authentication database 9 can be executed at an extremely high speed because the company member ID is uniquely identified by having the user pronounce his/her ID and executing voice recognition with respect to the pronounced ID. When the audibly input company member ID cannot be found as registered, an audio guidance is given to invite the user to pronounce his/her company member ID once more (step 203, 201). When it is confirmed that the company member ID is registered, the voiceprint information corresponding to the company member ID and the voiceprint obtained from the sound received from the cellular phone 1 are collated (step 204). When a match is detected as a result of collation, the user is determined to be an authorized user, and the state recorded in the user authentication database 9 regarding the log-in by the onetime ID corresponding to the company member ID concerned is changed to an allowed state (step 205, 206). At this point, the state of the log-in using the company member ID remains disallowed.

After providing to the user an audio guidance as to whether or not the authentication was successful, the CTI server 6 disconnects the channel over the telephone network 2 to thereby end the user authentication processing (step 207).

When the user confirms the completion of authentication through the audio guidance provided by the CTI server 6, the user presses the OK button according to the guidance displayed on the authentication screen (step 108). In response, the automatic log-in unit 17 transmits the internally retained onetime ID to the web server 4 so as to automatically log into the system. The log-in is possible at this point because the state of log-in by the onetime ID is changed to the allowed state in the step 206 after proper authentication of the user. If the OK button is pressed before the user is authenticated, log-in is unsuccessful because the state of log-in by the onetime ID remains disallowed until authentication has been successfully performed.

Upon confirmation of the user log-in, the web server 4 immediately and automatically deletes the onetime ID corresponding to that user using the onetime ID deleting section 12 (step 111). In this way, unauthorized log-in through re-use of the onetime ID is prevented. Subsequently, a main screen of the company system as shown for example in FIG. 4(c) is displayed on the cellular phone 1 (step 112). Because multiple log-ins by a single user are prohibited in the company proprietary system of the present embodiment, a log-in using the company member ID remains disallowed at this point.

When the user finishes using the company proprietary system and logs out of the system, the CTI server 6 instructs the database server 5 to change to an allowed state the state of log-in for this company member ID (step 113).

In conventional user authentication processing using a password, user collation is performed using a combination of a user name or user identification information, such as the company member ID of the present embodiment, and a onetime password. The user identification information is typically a sequence of characters configured based on the company member number, the name of the company member, or a combination of the two. Accordingly, the user identification information has a fair degree of regularity which provides clues which a third party can use to steal information. A password is therefore often assigned to maintain security and, to enhance the security strength, the password is often made complex. However, input of such a password is particularly troublesome, especially when using an instrument such as a cellular phone with only a limited number of keys.

In light of the above, the present embodiment presumes that the user identification information, which must be input by the user, may be known to others, and allows the user identification information to be configured using a simple sequence of characters. At the same time, a onetime ID, which need not be input by the user, is assigned corresponding to each user identification information. The one time ID is sufficiently complex so as to avoid being easily uncovered by a third party. In place of inputting a password using the device's keys, a voice input is required for execution voice authentication. Accordingly, to log in, only the user identification information, which can easily be input, need be designated using keystrokes.

According to the present embodiment, security can be maintained using the onetime ID, while reducing the input load imposed on the user for log-in by executing user authentication based on voiceprint.

Further, in the present embodiment, a log-in is performed by using the onetime ID as the password, rather than the company member ID. If the company member ID, which is a relatively simple sequence of characters, is used as the password, it is possible for a third party to log in using the company member ID during the short interval between the point when the voiceprint authentication using the company member ID (step 205) is completed and the actual log-in (step 108). By using a onetime ID which may be made complex, it is very unlikely, to the point of being practically impossible, for a third party to ascertain the onetime ID during the relatively very short interval in which this ID can be used. Moreover, in the present embodiment, the allowed or disallowed state of log-in is set and maintained using the onetime ID. Accordingly, even if the onetime ID is found by a third party, the one-time ID cannot be used for log-in when not authorized (i.e., during the time when the disallowed state of log-in is set).

While the company member ID was used as the user identification information in the above example embodiment, a member number or a telephone number, for example, may be used instead as long as the number uniquely defines one user. Further, when the user uses only one cellular phone, information uniquely assigned to the cellular phone may be used as the user identification information. In that case, the user can log in simply by pronouncing the identification information of that cellular phone 1, without performing any key strokes.

Although the present embodiment was described using, as an example, a cellular phone 1 having an Internet function as the communication terminal device with a voice input function, the present invention may be implemented using a telephony terminal device or an information terminal device such as a personal computer, as long as the device is provided with both a communication function and a voice input function.

What is claimed is:

1. A user authentication system which, to permit a log-in from a communication terminal device with a voice input-function, conducts user authentication based on user identification information uniquely identifying each user and a password corresponding to the user identification information, said system comprising:
a user authentication database for storing user identification information and voiceprint information while correlating the two information, said voiceprint information acquired when a user pronounces their user identification information; wherein
said user authentication is performed by collating voiceprint information identified by searching in said user authentication database for voiceprint information corresponding to user identification information in code format received via a data communication network from said communication terminal device with a voice input function, with a user identification information in voice format received via a telephone network from said communication terminal device.

2. A user authentication system comprising:
a communication terminal device with a voice input function, said communication terminal device being capable of logging into a system which may only be accessed after successful user authentication based on a user identification information uniquely identifying each user and a password corresponding to the user identification information;
a user authentication database for storing user identification information and voiceprint information while correlating the two information, said voiceprint information acquired when a user pronounces their user identification information;
a onetime identification information managing means which generates a onetime identification information upon receipt of a code-format user identification information from said communication terminal device via a data communication network, transmits said generated onetime identification information back to said communication terminal device via said data communication network, and records, in said user authentication database in correlation with said user identification information, a disallowed state of a log-in designating said onetime identification information as the password; and
a user authenticating means which, upon receipt of voice-format user identification information from said communication terminal device via a telephone network, conducts voiceprint authentication using said voice-format user identification information by referring to said user authentication database, and, when the authentication is successful, changes to an allowed state said state recorded in said user authentication database concerning the log-in by said onetime identification information; wherein
said communication terminal device with a voice input function comprises:
a code-format user identification information transmitting means for transmitting to said onetime identification information managing means, as said code-format user identification information, an identification information belonging to said individual communication terminal device or to the exclusive user of said individual communication terminal device;
a voice-format user identification information transmitting means for receiving a user identification information input by said user' voice and transmitting said audibly input information to said user authenticating means as said voice-format user identification information; and
an automatic log-in means for, after the authentication is completed by said user authenticating means, automatically logging into said system using said onetime identification information received from said onetime identification information managing means.

3. A user authentication system according to claim 2, wherein said user authenticating means comprises:
a voice recognizer for executing voice recognition with respect to said voice-format user identification information received from said communication terminal device via said telephone network, so as to generate said received information in a code format; and
a voiceprint authenticator for executing voice authentication by collating voiceprint information identified by searching in said user authentication database for voiceprint information corresponding to said user identification information generated by said voice recognizer, with said voice-format user identification information received from said communication terminal device.

4. A user authentication system according to claim 2, wherein
said code-format user identification information transmitting means displays on said communication terminal device a log-in display screen received from said system via said data communication network, and transmits to said onetime identification information managing means, as said code-format user identification information, a user name input through said log-in display screen.

5. A user authentication system according to claim 2, wherein
after receiving said onetime identification information from said onetime identification information managing means via said data communication network, said voice-format user identification information transmitting means transmits to said user authenticating means, as said voice-format user identification information, said audible input by said user following an audio guidance provided by said user authenticating means via said telephone network.

6. A user authentication system according to claim 2 further comprising:
a onetime identification information deleting means for, upon completion of a user log-in from said communication terminal device, automatically deleting the corresponding onetime identification information from said user authentication database.

7. A user authentication system according to claim 1, wherein
said communication terminal device is a cellular phone provided with an Internet function.

8. A user authentication system according to claim 2, wherein
said communication terminal device is a cellular phone provided with an Internet function.
